(19) United States
(12) Patent Application Publication
(10) Pub. No.: US 2011/0105210 A1
(43) Pub. Date: May 5, 2011

(54) METHOD OF GAMING, A GAME CONTROLLER AND A GAMING SYSTEM

(76) Inventor: Chi We CHIM, Beecroft (AU)

(21) Appl. No.: 12/916,933

(22) Filed: Nov. 1, 2010

(30) Foreign Application Priority Data
Nov. 5, 2009 (AU) 2009905399

(51) Int. Cl. A63F 13/10

(52) U.S. Cl. 463/16

(57) ABSTRACT

A method of gaming in a gaming system. The method includes controlling a probability of a trigger condition being met during a current play of a game based on game outcomes of related prior plays of the game, and making an award during the current play of the game upon the trigger condition being met.

### RELATED APPLICATIONS

This application claims priority to Australian Provisional Application No. 2009905399, having a filing date of Nov. 5, 2009, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The invention relates to a method of gaming, a game controller and a gaming system.

### BACKGROUND OF THE INVENTION

Some gaming systems such as electronic gaming machines have a feature game which may be triggered during a play of the game, for example, a series of free spins or a second screen feature.

While such gaming systems provide players with enjoyment, a need exists for alternative gaming systems in order to maintain or increase player enjoyment.

### BRIEF SUMMARY OF THE INVENTION

In a first aspect, the invention provides a method of gaming in a gaming system, the method comprising:

controlling a probability of a trigger condition being met during a current play of a game based on game outcomes of related prior plays of the game; and

making an award during the current play of the game upon the trigger condition being met.

In an embodiment, the method of gaming comprises increasing the probability of the trigger condition being met in the current play relative to the probability of the trigger condition being met in at least one related prior play of the game.

In an embodiment, the game comprises selecting symbols from a symbol set and controlling the probability comprises adjusting the symbols of the symbol set.

In an embodiment, the method of gaming comprises adding symbols to the symbol set.

In an embodiment, the game is a spinning reel game, the symbol set comprises a plurality of subsets corresponding to respective ones of a plurality of reels and selecting symbols comprises selecting symbols from each subset of symbols for display at a plurality of symbol display positions.

In an embodiment, the method of gaming comprises evaluating the symbols based on a wager.

In an embodiment, the method of gaming comprises determining during each evaluation whether to increment a count and adding a symbol when the count reaches a designated value.

In an embodiment, the count is represented as a total of accumulated symbols.

In an embodiment, controlling the probability comprises holding the probability at a maximum level once the maximum level is reached.

In an embodiment, the prior plays of the game are related to the current play of the game by having been played by the same player.

In an embodiment, making the award comprises awarding a feature game.

In a second aspect, the invention provides a game controller for a gaming system, the game controller comprising:

a trigger probability controller which controls a probability of a trigger condition being met during a current play of a game based on game outcomes of related prior plays of the game; and

a trigger monitor which causes an award to be made to during the current play of the game upon the trigger condition being met.

In a third aspect, the invention provides a gaming system comprising:

a display for displaying play of a game;

a game play mechanism operable to initiate plays of the game; and

a game controller arranged to:

control a probability of a trigger condition being met during a current play of a game based on game outcomes of related prior plays of the game; and

make an award during the current play of the game upon the trigger condition being met.

In a fourth aspect, the invention provides a gaming system comprising:

means for displaying play of a game;

means operable to initiate plays of the game; and

means for controlling a probability of a trigger condition being met during a current play of a game based on game outcomes of related prior plays of the game; and

means for making an award during the current play of the game upon the trigger condition being met.

In a fifth aspect, the invention provides a gaming machine comprising:

a cabinet;

a display mounted within the cabinet for displaying play of a game;

one or more input devices operable to place a wager and initiate a play of the game;

a game controller disposed within the cabinet and in data communication with the display and the input devices, the game controller comprising a processor and a memory containing instructions and related prior game data based on game outcomes of related prior plays of the game, the instructions executed by the processor in response to initiation of a play of the game with the input devices to conduct a play of a game in which the game controller controls a probability of a trigger condition being met during a current play of a game based on the related prior game data and makes an award during the current play of the game upon the trigger condition being met.

In a sixth aspect, the invention provides computer program code which when executed implements the above method.

In a seventh aspect, the invention provides a tangible computer readable medium comprising the above program code.

In an eighth aspect, the invention extends to transmitting the above program code.

### BRIEF DESCRIPTION OF SEVERAL VIEWS OF THE DRAWINGS

An exemplary embodiment of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

### DETAILED DESCRIPTION OF THE INVENTION

Referring to the drawings, there is shown a gaming system having a game controller arranged to implement a method of gaming wherein an award, for example an award of a feature game, is made as part of a play of the game when a trigger condition is met. The gaming system is arranged to control the probability of the trigger condition being met based on related prior plays of the game.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

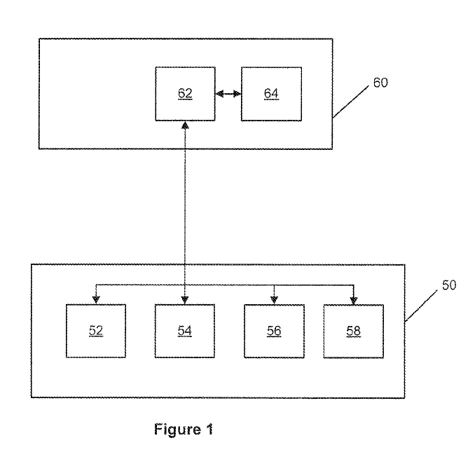

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

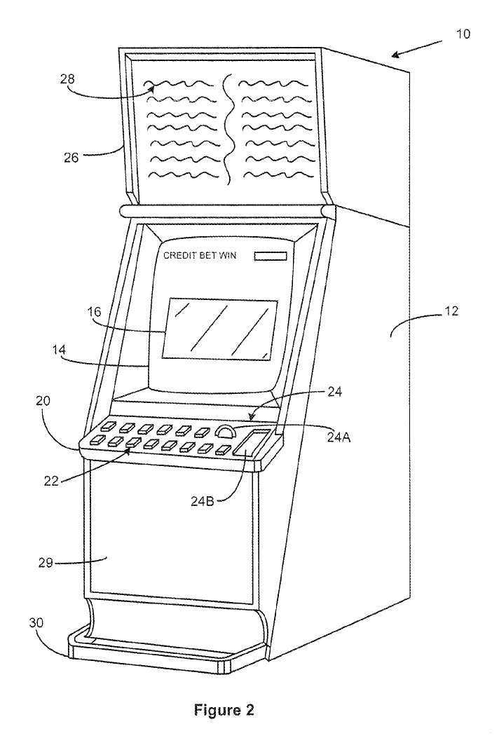

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

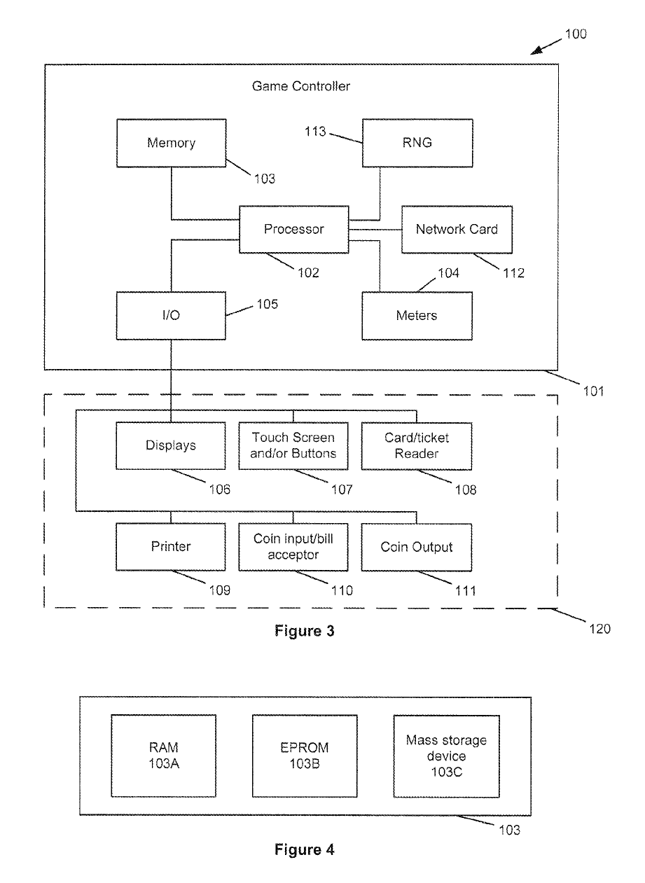

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

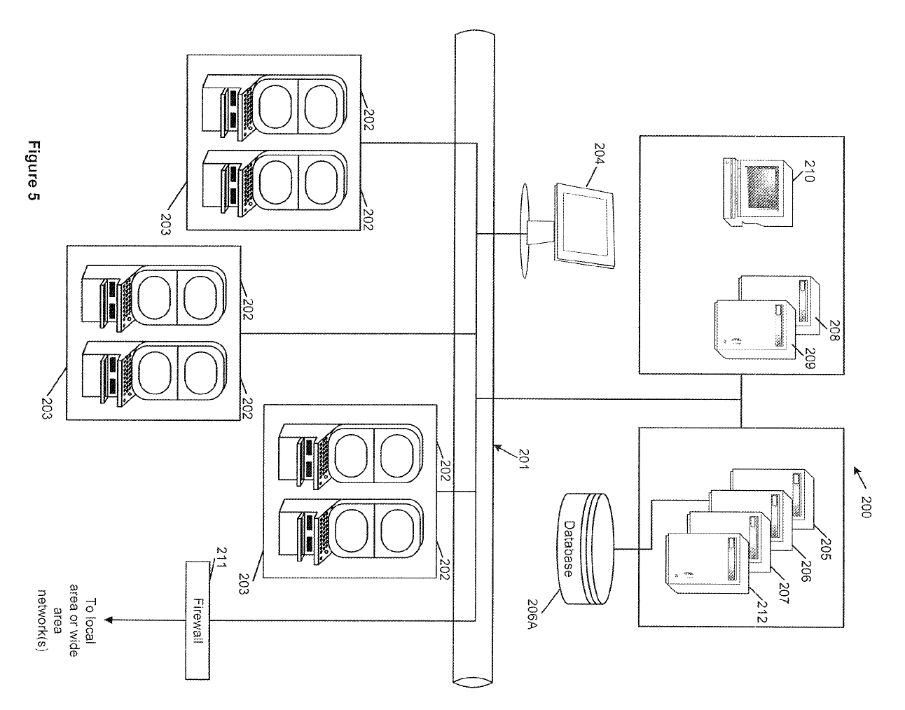

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 1038 or elsewhere.

It is also possible for the operative components of the gaming machine 100 to be distributed, for example input/output devices 106,107,108,109,110,111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

### Further Detail of Gaming System

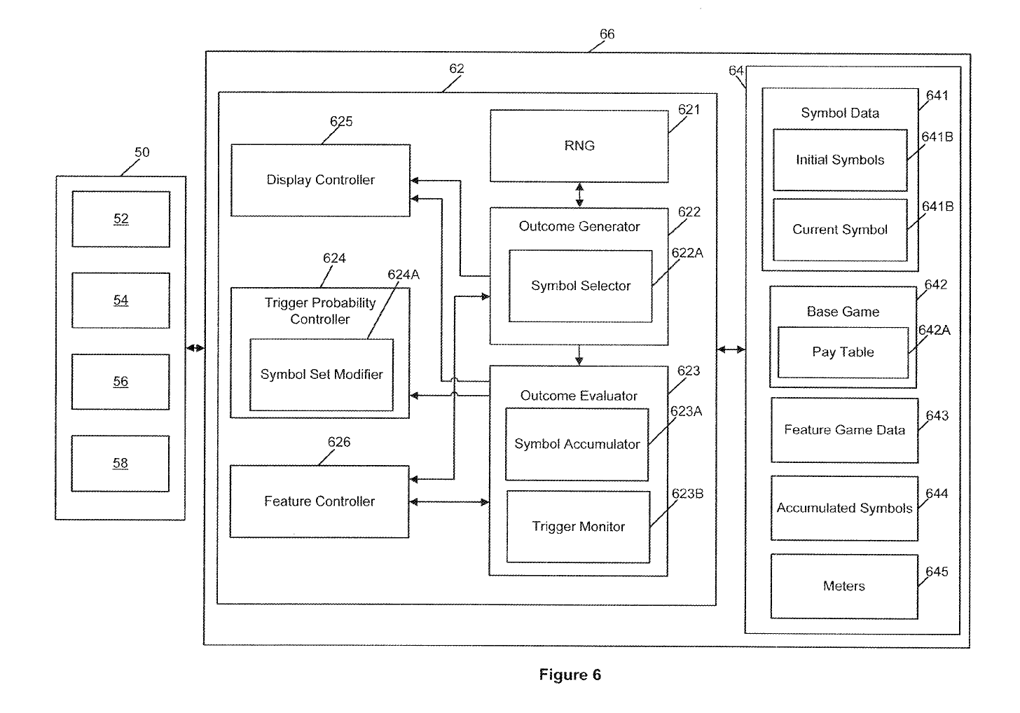

FIG. 6 shows a spinning reel game embodiment of a gaming system in which the player operates one or more of the input devices which make up the game play mechanism 56 to make a wager which will specify the win entitlement which will be evaluated for this play of the game and also to initiate a play of the game. In some examples, a single action may both place the wager and initiate a play of the game.

Persons skilled in the art will appreciate that a player's win entitlement will vary from game to game dependent on player selections. In most spinning reel games, it is typical for the player's entitlement to be affected by the amount they wager and selections they make (i.e. the nature of the wager). For example, a player's win entitlement may be based on how many lines they play in each game—e.g. a minimum of one line up to the maximum number of lines allowed by the game (noting that not all permutations of win lines may be available for selection). Such win lines are typically formed by a combination of symbol display positions, one from each reel, the symbol display positions being located relative to one another such that they form a line.

In many games, the player's win entitlement is not strictly limited to the lines they have selected, for example, “scatter” pays are awarded independently of a players selection of pay lines and are an inherent part of the win entitlement.

Persons skilled in the art, will appreciate that in other embodiments, the player may obtain a win entitlement by selecting a number of reels to play. Such games are marketed under the trade name “Reel Power” by Aristocrat Leisure Industries Pty Ltd. The selection of the reel means that each displayed symbol of the reel can be substituted for a symbol at one or more designated display positions. In other words, all symbols displayed at symbol display positions corresponding to a selected reel can be used to form symbol combinations with symbols displayed at a designated, symbol display positions of the other reels. For example, if there are five reels and three symbol display positions for each reel such that the symbol display positions comprise three rows of five symbol display positions, the symbols displayed in the centre row are used for non-selected reels. As a result, the total number of ways to win is determined by multiplying the number of active display positions of each reels, the active display positions being all display positions of each selected reel and the designated display position of the non-selected reels. As a result for five reels and fifteen display positions there are 243 ways to win.

In other embodiments a player win entitlement may be affected by purchasing access to particular pay tables—e.g. a first bet amount entitles the player to wins including cherries and a second amount entitles them to wins including plums.

In FIG. 6, the processor 62 of game controller 60 is shown implementing a number of modules based on program code and data stored in memory 64. Persons skilled in the art will appreciate that various of the modules could be implemented in some other way, for example by a dedicated circuit.

These modules include the outcome generator 622 which operates in response to the player's operation of game play mechanism 56 to place a wager and initiate a play of the game and generates a game outcome which is evaluated by award evaluator 623. The outcome generator 622 a symbol selector 622A to select symbols from a set of symbols specified by symbol data 641 using random number generator 621. Visual data corresponding to the selected symbols is advised to the display controller 624 which causes them to be displayed on display 54 at a set of symbol display positions.

One example of selecting symbols is for the symbol selector 622A to select symbols for display from a plurality of symbol sets corresponding to respective ones of a plurality of spinning reels stored as symbol data. (The symbol sets can also be viewed as subsets of a symbol set provided for the whole game.) The symbol sets can specify a sequence of symbols for each reel such that the symbol selector 622A can select all of the symbols by selecting a stopping position in the sequence. In one example, three symbols of each of five reels may be displayed such that symbols are displayed at fifteen symbol display positions on display 54.

From FIG. 6, it will be apparent that the symbol data 641 includes initial symbols 641A and current symbols 641B. This is because in the embodiment the trigger condition is a symbol combination and the game controller 62 controls the probability of the trigger condition being met by adjusting the symbol sets to increase the probability of the trigger condition being met. Specifically, in the embodiment, the trigger condition is that a symbol combination occurs and hence, the probability of the symbol combination being met can be increased by adjusting the number of symbols which can participate in the triggering symbol combination on one or more of the reels. For example, if the trigger is that three scattered designated symbols appear in the symbol display positions, the probability can be adjusted by adding a symbol to any of the reels.

Thus the game controller 60 is arranged to monitor play of the game and alter the current symbols 641B of the symbol set to adjust the probability odds based on outcomes in prior games. The game controller is arranged to determine which of these prior game outcomes are related, preferably such that the games can be ascribed to a particular player. In an embodiment, this is achieved by monitoring when a player tracking card is entered into a card reader of the gaming machine or an associated a player tracking module connected to the gaming machine, such that the initial set of symbols is used when a player tracking card is first entered and the current set of symbols 641B is used as that set of symbols is modified during play. In other embodiments, the game controller 60 may be arranged to determine whether the games are related based on timing criteria being met in respect of the games, for example, if there is a delay of less than 30 seconds between plays of the game they may be deemed related. In such embodiments, the player may be warned (for example by messages on display 56) that if they do not initiate a play they will lose the entitlement to an increased trigger probability. In embodiments where a tracking card is used, the player may be entitled to take their entitlement to an increased trigger probability with them at the end of gaming session as the game controller may be arranged to cause the entitlement to be written to a player tracking card. In such embodiments, it will be apparent that the game controller 60 will be arranged to check the player tracking card at the beginning of the new gaming session to see whether there is any existing entitlement to a modified symbol set and hence a modified trigger symbol set applies at the beginning of a new gaming session and to adjust the current symbol set 641B accordingly.

In the embodiment shown in FIG. 6 the outcome evaluator 623 is arranged to evaluate outcomes of the game against a pay table which forms part of the base game data 642. The outcome evaluator 623 is also arranged to increment a count towards adjustment of the symbol set. In the embodiment, this count is a count of the symbols which are accumulated based on outcomes of the game. To this end, outcome evaluator 623 includes a symbol accumulator 623A which processes the game outcome and determines whether a designated symbol has occurred during game. Each time the symbol occurs, this symbol is added to the count and is stored as a accumulated symbol data 644. The trigger probability controller 624 monitors the total of the count and when the total reaches a designated value, the symbol set modifier 624A of the trigger probability controller 624 adds trigger combination symbol to the current symbol set. The count can then be reset or continue until further designated values are reached depending on the implementation. In an embodiment, the symbol set modifier 624A adds this symbol by placing an additional symbol in the symbol set of one of the reels, each time sufficient symbols are accumulated. In the embodiment, this is achieved by adding these symbols to the set of symbols. In other embodiments, this can achieved by replacing symbols in the symbol set, for example symbols which are not involved in winning combinations. In another embodiment, there could be a plurality of possible sets of symbols and the probability could be adjusted by selecting which of the sets is to be the current set. The symbol set as adjusted will be available in the next play of the game.

In this respect, any play of the game may include one or more game rounds and if the trigger condition is met, a feature game is initiated under the control of the feature game controller which causes outcome generator and outcome evaluator to operate in accordance with feature game data 643.

Trigger probability controller 624 is arranged to cap the potential increase to the probability of the trigger condition being met. In the embodiment, this is achieved by capping the number of symbols which can be added. During play of the game, any wins awarded to the player are recorded on a win meter in meter data 645 while the meter data 645 also include a credit meter which maintains the player's current credit balance.

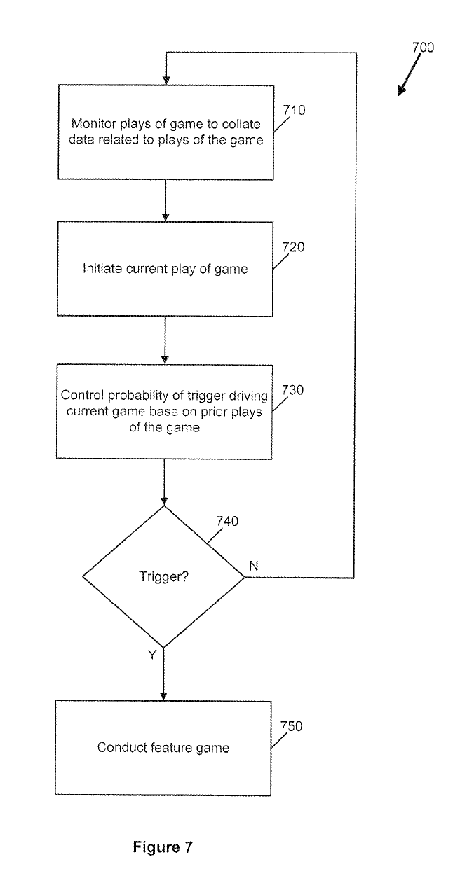

The method of the embodiment is summarised in FIG. 7 which shows that the method 700 includes monitoring 710 players of the game to collate data related to plays of the game. The method then involves initiating 720 the current play of the game and controlling 730 the probability of a trigger during current game based on prior plays of the game. In the embodiment, this probability is controlled by updating the symbol set which will apply for the next game on the outcome of the previous game as necessary. The method then involves determining 740 whether a trigger condition has been met and when the condition is met conducting 750 a feature game.

In some embodiments, an eligibility criteria may need to be satisfied before the player becomes eligible for the probability of the trigger condition being adjusted, for example that the player has made a certain sized wager, made an ante bet, selected all win lines, played sufficient games, or the player is a member of a loyalty program.

Further aspects of the method will be apparent from the above description of the gaming system. Persons skilled in the art will also appreciate that the method could be embodied in program code. The program code could be supplied in a number of ways, for example on a computer readable storage medium, such as a disc or a memory (for example, that could replace part of memory 103) or as a data signal (for example, by transmitting it from a server).

### Example

In the example, lion symbols are “captured” when a five of a kind lion is spun up—i.e. when five lions appear in a winning combination on the reels. In the example for each 10 lions that are captured an additional lion is added to the fifth reel. In the example, the accumulation of lions affects the probability of a second screen feature being triggered. The trigger condition for the feature is that when lions are spun up on reel 1 and lions or diamonds are spun up on reel 5. When this occurs, the player wins bonus credits in a second screen feature. Up to five lions may be captured. As a result, the game starts at a returned to player of 87.4% and will peak at 90.6%. In the example, the lions are captured at a rate of one every 300 spins on average. As a result initially the second screen feature game will occur 1 in 262 spins initially and the probability will increase to 1 in 94 spins. In the embodiment, the feature game is one of two feature games which are available. The other feature being a free game feature which is triggered with 3 scattered symbols. During the free games an additional wild diamond symbol is added to reels 2, 3, 4 and 5 for each free game and accordingly the combined feature hit rates starts at 1 in 88 spins and caps at 1 in every 56 spins. Capturing of the lions, and hence modification of symbol set results in bigger wins at a more frequent rate.

Persons skilled in the art will appreciate that in other embodiments, rather than a feature game being awarded in response to modification of the trigger condition another award, such as a prize may be made to the player.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming in a gaming system, the method comprising:
controlling a probability of a trigger condition being met during a current play of a game based on game outcomes of related prior plays of the game; and
making an award during the current play of the game upon the trigger condition being met.

2. A method of gaming as claimed in claim 1, comprising increasing the probability of the trigger condition being met in the current play relative to the probability of the trigger condition being met in at least one related prior play of the game.

3. A method of gaming as claimed in claim 1, wherein the game comprises selecting symbols from a symbol set and controlling the probability comprises adjusting the symbols of the symbol set.

4. A method of gaming as claimed in claim 3, comprising adding symbols to the symbol set.

5. A method as claimed in claim 3, wherein the game is a spinning reel game, the symbol set comprises a plurality of subsets corresponding to respective ones of a plurality of reels and selecting symbols comprises selecting symbols from each subset of symbols for display at a plurality of symbol display positions.

6. A method as claimed in claim 5, comprising evaluating the symbols based on a wager.

7. A method as claimed in claim 6, comprising determining during each evaluation whether to increment a count and adding a symbol when the count reaches a designated value.

8. A method as claimed in claim 7, wherein the count is represented as a total of accumulated symbols.

9. A method as claimed in claim 1, wherein controlling the probability comprises holding the probability at a maximum level once the maximum level is reached.

10. A method as claimed in claim 1, wherein the prior plays of the game are related to the current play of the game by having been played by the same player.

11. A method as claimed in claim 1, wherein making the award comprises awarding a feature game.

12. A game controller for a gaming system, the game controller comprising:
a trigger probability controller which controls a probability of a trigger condition being met during a current play of a game based on game outcomes of related prior plays of the game; and
a trigger monitor which causes an award to be made to during the current play of the game upon the trigger condition being met.

13. A game controller as claimed in claim 12, wherein the trigger probability controller increases the probability of the trigger condition being met in the current play relative to the probability of the trigger condition being met in at least one related prior play of the game.

14. A game controller as claimed in claim 12, wherein the game comprises selecting symbols from a symbol set and the trigger probability controller controls the probability by adjusting the symbols of the symbol set.

15. A game controller as claimed in claim 14, wherein the trigger probability controller adds symbols to the symbol set.

16. A game controller as claimed in claim 14, wherein the game is a spinning reel game, the symbol set comprises a plurality of subsets corresponding to respective ones of a plurality of reels and the game controller comprises a symbol selector arranged to select symbols from each subset of symbols for display at a plurality of symbol display positions.

17. A game controller as claimed in claim 14, comprising an outcome evaluator arranged to evaluate the symbols based on a wager.

18. A game controller as claimed in claim 17, further arranged to determine during each evaluation whether to increment a count and adding a symbol when the count reaches a designated value.

19. A game controller as claimed in claim 18, wherein the count is represented as a total of accumulated symbols.

20. A game controller as claimed in claim 12, arranged to control the probability by holding the probability at a maximum level once the maximum level is reached.

21. A game controller as claimed in claim 1, wherein the game controller is arranged to determine that the prior plays of the game are related to the current play of the game by having been played by the same player.

22. A game controller as claimed in claim 12, arranged to make the award by awarding a feature game.

23. A gaming system comprising:
a display for displaying a game;
a game play mechanism operable to initiate plays of the game; and
a game controller arranged to:
control a probability of a trigger condition being met during a current play of a game based on game outcomes of related prior plays of the game; and
make an award during the current play of the game upon the trigger condition being met.

24. A gaming system as claimed in claim 23, wherein the game controller is arranged to increase the probability of the trigger condition being met in the current play relative to the probability of the trigger condition being met in at least one related prior play of the game.

25. A gaming system as claimed in claim 23, wherein the game comprises selecting symbols from a symbol set and the game controller controls the probability by adjusting the symbols of the symbol set.

26. A gaming system as claimed in claim 25, wherein the game controller adds symbols to the symbol set.

27. A gaming system as claimed in claim 25, wherein the game is a spinning reel game, the symbol set comprises a plurality of subsets corresponding to respective ones of a plurality of reels and the game controller selects symbols from each subset of symbols for display at a plurality of symbol display positions on the display.

28. A gaming system as claimed in claim 25, wherein the game controller evaluates the symbols based on a wager.

29. A gaming system as claimed in claim 28, comprising determining during each evaluation whether to increment a count and adding a symbol when the count reaches a designated value.

30. A gaming system as claimed in claim 29, wherein the count is represented as a total of accumulated symbols.

31. A gaming system as claimed in claim 23, wherein the game controller controls the probability by holding the probability at a maximum level once the maximum level is reached.

32. A gaming system as claimed in claim 23, wherein the game controller is arranged to determine that the prior plays of the game are related to the current play of the game by having been played by the same player.

33. A gaming system as claimed in claim 23, wherein the game controller makes the award by awarding a feature game.

34. A gaming system comprising:
means for displaying play of a game;
means operable to initiate plays of the game; and
means for controlling a probability of a trigger condition being met during a current play of a game based on game outcomes of related prior plays of the game; and
means for making an award during the current play of the game upon the trigger condition being met.

35. A gaming machine comprising:
a cabinet;
a display mounted within the cabinet for displaying play of a game;
one or more input devices operable to place a wager and initiate a play of the game;
a game controller disposed within the cabinet and in data communication with the display and the input devices, the game controller comprising a processor and a memory containing instructions and related prior game data based on game outcomes of related prior plays of the game, the instructions executed by the processor in response to initiation of a play of the game with the input devices to conduct a play of a game in which the game controller controls a probability of a trigger condition being met during a current play of a game based on the related prior game data and makes an award during the current play of the game upon the trigger condition being met.

36. A method of gaming as claimed in claim 1, further comprising executing computer program code to control the probability and to make the award.

37. A method of gaming as claimed in claim 36, further comprising storing the computer program code in a tangible computer readable medium.
